(19) United States
(12) Patent Application Publication
(10) Pub. No.: US 2020/0011012 A1
(43) Pub. Date: Jan. 9, 2020

(54) Method for producing reactive lignin

(71) Applicant: Teknologian tutkimuskeskus VTT Oy, Espoo (FI)

(72) Inventors: Hanne Wikberg, VTT (FI); Taina Ohra-Aho, VTT (FI); Juha Leppävuori, VTT (FI); Tiina Liitiä, VTT (FI); Heimo Kanerva, VTT (FI)

(21) Appl. No.: 16/470,260

(22) PCT Filed: Dec. 21, 2017
(86) PCT No.: PCT/FI2017/050927

§ 371 Date: Jun. 17, 2019

(30) Foreign Application Priority Data
Dec. 21, 2016 (FI) 20166008
Dec. 21, 2016 (FI) 20166009

(51) Int. Cl. D21C 11/00; C07G 1/00

(52) U.S. Cl. CPC D21C 11/0007; D21C 3/02; C07G 1/00

(57) ABSTRACT

According to an aspect of the present invention, there is provided a method of producing reactive lignin from an alkaline lignin containing stream, such as black liquor, e.g. kraft lignin, by using thermal treatment with temperatures between 200 and 300° C., and a retention time of 1 h or less, for activation of the lignin.

### FIELD

The present invention relates to a method for activating lignin from an alkaline lignin containing stream, such as black liquor. More precisely, this invention relates to a lignin product obtained and the use of the product.

### BACKGROUND

Black liquor is the by-product from alkaline pulping processes, such as kraft and soda pulping, where most of the lignin, but also some hemicelluloses and extractives are removed from the lignocellulosic feedstocks to free the cellulosic fibers for paper making. Black liquor contains more than half of the energy content of the wood fed into the digester, and pulp mills typically use black liquor as an energy source by combusting it in the recovery boiler.

Lignin is the main organic component in black liquor. It is aromatic biopolymer, and in addition to use as energy source, it could also find higher value uses as a sustainable bio-based raw material in chemical industry. Therefore, lignin separation technologies have been recently developed, and some of them have been implemented into commercial scale. All presently available lignin separation technologies, such as LignoBoost, LignoForce and SLRP, are based on lignin precipitation by acidification using carbon dioxide. Precipitated lignin is then purified, e.g. by using two-step acidic washing process as described in EP 1794363. In this washing step the final pH is around 2.5. According to some alternatives, the black liquor is oxidized at 75° C. before acidification to improve the filtration properties. It is also possible to precipitate the lignin continuously in a column reactor, e.g. at slightly higher temperature (such as 115° C. at a pressure of 6.2 bar). Typically, dense liquid-lignin droplets are then formed, which coalesce into a bulk liquid-lignin phase that can be separated by gravity. The liquid lignin is then typically reacted continuously with sulfuric acid to achieve a pH of 2-3 as in other processes. Currently, the precipitated lignins are mainly used as fuel.

Other approaches for upgrading black liquor have also been investigated. WO 2012/091906 describes a process to reduce one or more insoluble solids from heat-treated black liquor comprising the steps of providing a black liquor stream and treating the black liquor at an increased temperature 250-300° C. for an effective time to reduce the amount of one or more insoluble solids by more than 40 wt %. In the process, lignin is depolymerized to lower molecular weight lignin compounds, such as phenolic oligomers and monomers. These compounds are dissolved, thus reducing the solids composition in the black liquor. Afterwards, the produced liquid including the degraded compounds can be separated and processed for use in downstream aromatic and other chemical processes. However, in the publication thermal treatment is used to degrade lignin in black liquor to produce lower molecular weight compounds. In the present invention the polymeric structure of precipitated lignin remains and the solid lignin yield is in a comparable level than with the conventional lignin precipitation technologies using acid precipitation.

Similarly, WO2016/207493 describes a process, wherein black liquor is subjected to a thermal treatment at a temperature between 200 and 250° C. during 0.5 to 10 h in order to activate and simultaneously precipitate the lignin of the feedstock. In the present invention the lignin precipitation during heat treatment will be prevented by operating at higher pH.

EP 2591166 (Stora Enso) is, in turn, directed to a thermal treatment of black liquor at temperatures of 150 to 200° C. during a short retention time that preferably is 1-5 minutes, and to a subsequent precipitation in order to produce a lignin with a low hemicellulose content, lower molar mass and thus reduced viscosity, to be used in biorefinery-related applications. No activation of the lignin takes place using such a low temperatures and short times.

EP 3036247 (Valmet) describes a process for precipitating lignin using an acid treatment step, and subsequently subjecting the separated lignin fraction to carbonization, while EP 3030598 and WO 2016/020383 (Suncoal Industries) describe a process for extracting carbonized lignin from black liquor using a pH adjustment and a hydrothermal carbonization.

High temperatures together with long residence times cause carbonization by decreasing the amount of hydrogen and oxygen, while polymerization and condensation increase the molecular weight of the product. The carbonization methods are, thus, particularly aimed for producing carbon-rich products, using high temperatures combined with long retention times.

U.S. Pat. No. 2,976,273 describes a process for treating residual black liquor from the kraft pulping process whereby dimethyl sulphide is produced, lignin contained in the black liquor is modified and the aliphatic acid content in the black liquor is substantially increased. The process comprises a heat treatment in the range from 220° to 350° C. During the heating methoxy groups react with the sulphur compounds to form dimethyl sulphide. After heat treatment lignin is precipitated by an acidification process. The process described in U.S. Pat. No. 2,976,273 runs at pH below 12, and it is known that some lignin precipitatates during thermal treatment in such pH range. In the present invention, initial pH is above 12 to prevent lignin precipitation during heat treatment to avoid scaling problems.

### SUMMARY OF THE INVENTION

The invention is defined by the features of the independent claims. Some specific embodiments are defined in the dependent claims.

According to a first aspect, it is provided herein a thermal treatment method for activating lignin from lignin containing streams.

According to a second aspect, it is provided herein an activation method for producing reactive lignin, which has specific structure and properties that can be altered by varying the process conditions.

According to a further aspect, the structure of separated lignin and the degree of activation is also dependent on the composition of the raw material stream, favouring especially alkaline lignin containing streams, such as black liquor from kraft processes.

According to even further aspect, structure of the final lignin can be modified in alkaline raw materials by optional adding of acid either before or during and after the thermal treatment.

The present invention thus aims at activating lignin before separation from dissolved lignin containing streams. In contrast to technologies described in prior art, this invention uses heat treatment to chemically activate the lignin, while the prior art focuses on either depolymerizing lignin at higher temperatures or carbonizing and hence condensating the lignin with longer reaction times. The carbonization is, on the contrary, avoided and condensation minimised in the present invention, by selecting a suitable combination of reaction conditions (particularly temperature, pH and retention time) with main focus on lignin activation.

The present invention provides means for enabling the utilization of lignin in higher value products than fuel, such as in phenol formaldehyde (PF) and other resins (e.g. polyurethane (PU), and epoxy resins), antioxidants, surface active dispersants, surfactants or chelates, UV-stabilizers, reinforcing fillers and pigments in various applications such as in tyre and other rubber products and composites. Alternatively, the activated and separated lignin can be used as a raw material in activated carbon manufacture.

Considerable advantages are obtained by means of the invention. High temperature with optional pH adjustment before or during thermal treatment is utilized for lignin activation to produce reactive lignin with desired structure that can be separated from thermally treated black liquor using acidic precipitation. The new process leads to significant lignin demethylation and/or demethoxylation, providing unique method for producing highly reactive lignin, for example for PF, PU and epoxy resin applications, or highly functional lignin for composite, dispersant, antioxidant, chelation or hot-melt adhesive applications, or for any other application typically considered for lignin. Unlike the publications describing methods to carbonize lignin using high temperatures and long retention times causing polymerization and condensation, the present application uses a shorter thermal treatment times, which activates lignin by demethylating/demethoxylating and creates more phenolic functionalities.

The amount of the reactive sites of lignin increases significantly compared to the present commercial acid precipitated kraft lignins, making the lignin material more suitable for several applications.

The structure of the produced lignin can be optimized in the process by varying process conditions so that the lignin material can be utilized in thermoset resins, or in rubber, plastic and glue applications, or as replacement of fossil-based carbon black, as additive providing reinforcement, UV-stability, antioxidative properties, colouring and thermal stability for applications such as rubber, composites, inks and paints. Alternatively, it can be used as a raw material in activated carbon manufacture.

Next, the present technology will be described more closely with reference to the drawings and to certain embodiments.

### EMBODIMENTS

The present invention is illustrated in the attached drawings, where

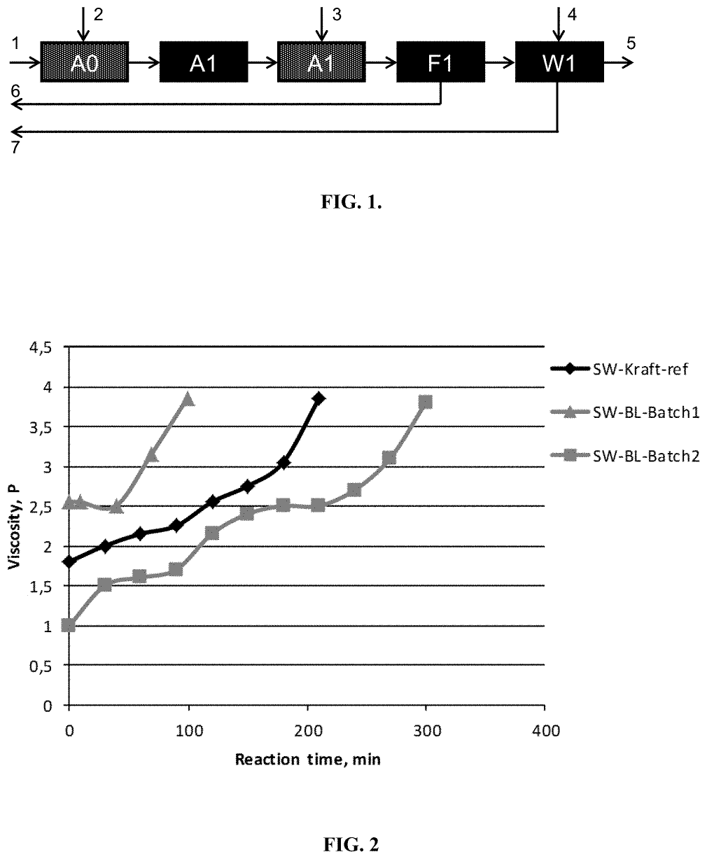

FIG. 1 illustrates the general concept of the present technology,

FIG. 2 is a graphical presentation of the viscosity development in PF (phenol formaldehyde) resin synthesis, and

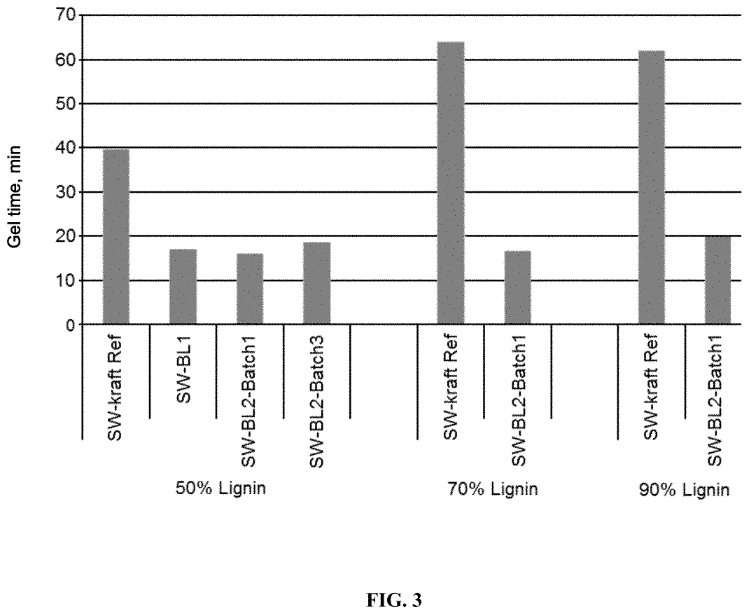

FIG. 3 is a graphical presentation of resin curing at high phenol substitution levels.

Thus the present invention relates to a method of producing highly reactive lignin from dissolved lignin containing streams, such as black liquor. The general concept of the present technology is shown in FIG. 1, where the dissolved lignin containing stream (1) in a dry matter content between 10 and 50% is subjected to an optional pHadjustment step (A0) before or during a heat treatment step (HT), followed by acidification step (A1), filtration step (F1), and acidic washing step (W1). In case that the lignin containing stream is black liquor from kraft pulp mill, a fraction of the black liquor stream is extracted from evaporation plant to the lignin extraction (1). The filtrates from the filtration step (6) and washing step (7) are returned to the evaporation plant.

The method of the invention thus comprises carrying out a thermal treatment on an alkaline lignin-containing feedstock by applying temperatures of more than 200° C., preferably within the range of from more than 220 to less than 300° C., for example within the range of from more than 250 to less than 280° C., and a retention time of 1 h or less, preferably between 0.05 and 1 h, more preferably from 0.1 to <1 hours, and subsequently separating the precipitated lignin material from the filtrate after reduction of pH.

Such thermal treatment increases the reactivity, i.e. the amount of reactive sites, of lignin, without causing any significant condensation or carbonization.

The first optional pH adjustment step (A0) is intended to adjust the pH to a value remaining above 12. In case of the lignin containing stream being black liquor, this optional slight pH adjustment does not cause any precipitation of the lignin but enables further modification of lignin structure during heat treatment. For alkaline streams, pH adjustment (2) is done by introducing any acidic steam, such as CO₂, acidic exhaust gases, sulfuric acid, citric acid etc.

The heat treatment step (HT) is done in a temperature between 200 and 300° C. for a time of 1 hour or less, in order to facilitate activation of the lignin. In contrast to the methods described in prior art, the goal of the heat treatment is to activate the lignin, not to carbonize or condensate the lignin or to depolymerize it in a way that the solid lignin yield will be decreased.

Preferably, the method operates at a temperature between 220 and 280° C., particularly at a temperature of between 250 and 280° C., during a retention time of less than 1 h, preferably between 0.05 and <1 h.

The process is preferably operated at a the vapour pressure of the black liquor or higher.

Typically, the method is operated at an alkaline pH, above 12, preferably above 12.5. Structure of the final lignin can be modified in alkaline raw materials by optional addition of acid for adjusting the pH to desired level before or during the thermal treatment. Preferably, pH of the lignin containing stream is adjusted to a value above 12 prior to the heat treatment. By means of such pH adjustment, it is possible to control the structure of the resulting lignin. By maintaining initial pH above 12, preferably even higher, lignin precipitation during heat treatment and possible scaling problems will be prevented.

In order to precipitate activated lignin, an acidification step (A1) will be carried out. In said step, pH of the liquor is lowered below pH 11, preferably to a pH range of 9-10 in order to precipitate lignin. Acidification agent (3) can be any acid, particularly any commonly used and readily available acid, e.g. carbon dioxide, carbonic acid, acidic exhaust gas, sulfuric acid, hydrochloric acid, nitric acid, citric acid or acetic acid, preferably carbon dioxide, acidic exhaust gas or sulphuric acid. The filtration step can be performed using any solid-liquid separation equipment such as filter press, belt press, centrifuge etc.

Acidic washing step (W1) is carried out to purify the precipitated lignin. Preferably acidic washing water (4) is used, most suitably at pH 2-3. In FIG. 1, stream 5 represents the washed lignin.

Using this embodiment, lignin with highly reduced methoxyl content can be produced from alkaline lignin containing feedstock, obtained for example from alkaline pulping process, such as kraft black liquor, by using the method of the present invention as herein described, in which lignin is activated during thermal treatment prior to separation.

Lignin activation through demethylation and/or demethoxylation provides better means for utilisation of otherwise less reactive lignin. Further, the present invention provides means for adjusting the lignin structure, e.g. by providing a more narrow range for the molar mass, higher reactivity and lower degree of condensation of the lignin product, compared to the prior processes.

Important features of the above embodiment of the invention are that carbonization and condensation is avoided by maintaining a short retention time in the thermal treatment. On the other hand, lignin is nor liquefied by reducing the solids composition in the black liquor. By maintaining initial pH above 12, lignin precipitation during heat treatment and possible scaling problems will be prevented.

The process is suitable for alkaline lignin containing streams where lignin is either dissolved or colloidal, such as streams from kraft, cooking processes. Particularly, the selected stream originates from the kraft process, whereby kraft black liquor is used.

The process is especially beneficial for hardwood black liquor that contains lignin with highly methoxylated syringyl units that are not reactive with e.g. formaldehyde.

Thus, according to a preferred embodiment, the method of the present invention includes the following steps:
placing black liquor having dry content of 10-50 wt-%, into a reactor,
optionally, adjusting pH of the black liquor by using a pH lowering agent, to obtain a pH higher than 12 before or during the following heat treatment step,
thermally treating the optionally pH-adjusted black liquor in temperatures between >200° C. and 300° C. under pressure that is the vapour pressure of the black liquor between 15 and 90 bars or higher for less than 1 hour, adjusting the pH 9-10 of the liquid fraction, and thus precipitating and recovering lignin,
washing the separated lignin fractions at pH 2-3 one or more times to purify the lignin, and
drying of precipitated lignin product.

In addition to the production method, a lignin material obtainable by the herein described process belongs to the scope of the present invention.

Such lignin material may be used for example in phenol formaldehyde, epoxy, and polyurethane resin applications, in composites, rubber, dispersants, antioxidants and hot-melt adhesives.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in generating highly reactive or functional lignin, which makes the lignin material more suitable for several industrial applications, such as in manufacturing PF, epoxy and polyurethane resins, composites, dispersants, antioxidants, hot melt adhesives, rubber and plastic products, and metal chelation e.g. in waste water treatment. Alternatively, the lignin can be used as a raw material in activated carbon manufacture, or for other carbonized products.

### EXAMPLES

### Example 1—General Method

### Raw Material

Black liquor from softwood and hardwood kraft pulping process
Dry content of the raw material: 10-50 wt-%, Trials done at between 30 wt-% and 40 wt-%

Method
Temperature of 200 to 250° C.
Residence time 1 h or less
Self-generated pressure 15-40 bar
pH alkaline, above 12
Product purification after the activation and precipitation: the lignin material is purified by acidic washing

In this example, black liquor from softwood and hardwood kraft pulping processes having dry content of 30-40 wt-% was placed into a reactor and pH was adjusted above 12 using CO₂ as a pH lowering agent. Then the black liquor was thermally treated in the temperature of 200 and 220° C. under pressures between 15-40 bars for 1 hour or less. Then the activated and precipitated lignin was separated from the remaining liquid in a centrifuge. The separated lignin was purified using acidic washing and dried.

Table 1 shows the amounts of different phenolic hydroxyl group species (mmol/g) in softwood (SW) and hardwood (HW) lignin samples after the thermal treatment determined by ³¹P NMR. Significantly lower amount of methoxylated guaiacyl units and higher content of non-methoxylated catechol and p-hydroxyphenyl type units was detected compared to a to typical industrial softwood and hardwood kraft lignins recovered by traditional acidic precipitation when thermal treatment was performed at 220° C., showing the activating effect of the method. Total content of phenolic hydroxyl and carboxylic acid groups was also higher, whereas the content of aliphatic hydroxyl groups was lower. The performance was similar for black liquors (BL) originating from different pulp mills regardless of the wood species (SW-BL1, SW-BL2, HW-BL), and also when process was scaled-up from laboratory to pilot. However, at temperatures lower than 200° C. the activating effect was not detected.

TABLE 1

| | Aliphatic | Carboxylic | Condensed | | | p-OH- | Phenolic | Total | |
|---|---|---|---|---|---|---|---|---|---|
| mmol/g | OH | acid | (+syringyl) | Guaiacyl | Catechols | phenyl | OH | OH | % OCH3^{c)} |
| Softwood | | | | | | | | | |
| SW-BL1- | 0.9 | 0.7 | 2.4 | 1.2 | 1.2 | 0.7 | 5.5 | 7.1 | |
| 220C | | | | | | | | | |
| SW-BL2- | 0.8 | 0.8 | 2.5 | 1.1 | 1.6 | 1.2 | 6.4 | 8 | |
| 220C-Batch1 | | | | | | | | | |
| SW-BL2- | 0.8 | 0.8 | 2.2 | 1.0 | 1.4 | 0.8 | 5.4 | 7 | |
| 220C-Batch2 | | | | | | | | | |
| SW-BL2- | 0.7 | 0.8 | 2.7 | 0.9 | 1.9 | 1.3 | 6.8 | 8.3 | |
| 220C-Batch3 | | | | | | | | | |
| SW-BL2- | 0.7 | 0.8 | 2.5 | 1 | 1.8 | 1.3 | 6.6 | 7.6 | |
| 220C-Pilot | | | | | | | | | |
| SW-BL2- | 0.6 | 0.4 | 0.9 | 0.3 | 0.4 | 0.2 | 1.9 | 2.8 | |
| 200C | | | | | | | | | |
| Reference | | | | | | | | | |
| lignins: | | | | | | | | | |
| commercial | 1.7 | 0.4 | 2.0 | 2.3 | 0.00 | 0.2 | 4.4 | 6.5 | 12.9 |
| lignin | | | | | | | | | |
| Indulin AT^{a)} | 2.0 | 0.2 | 1.6 | 2.3 | | 0.3 | 4.3 | 7.6 | 14.6 |
| Hardwood | | | | | | | | | |
| HW-BL-220C | 0.7 | 0.8 | 3.8 | 0.6 | 1.5 | 0.8 | 6.7 | 8.2 | |
| Reference | | | | | | | | | |
| lignin: | | | | | | | | | |
| HW KL^{b)} | 1.5 | 0.6 | 2.4 | 0.5 | 0.3 | 0.2 | 3.4 | 5.5 | 17.4 |
| Kraft Lignin^{a)} | 0.9 | 0.2 | | | | | 2.8 | 3.8 | |

^{a)}Beis S H (2010) Fast pyrolysis of lignin. BioResources 5(3) 1408-1424
^{b)}Hardwood kraft lignin precipitated from black liquor at pH 2.5 with hydrochloric acid
^{c)}All values are measured according to Pregl.

Table 2 shows the average molar mass values of softwood and hardwood lignins determined by SEC in 0.1 M NaOH relative to the polystyrene sulphonate standards. Results show that the polymeric nature of lignin is retained. Softwood black liquor samples SW-BL2-Batch2 and SW-BL2-Batch3 show that the molar mass of lignin can be varied by selection of process conditions in addition to the activating effect.

TABLE 2

| | Mn | MW | PD |
|---|---|---|---|
| Softwood | | | |
| SW-BL1 | 1800 | 3100 | |
| SW-BL2-Batch1 | 2100 | 3700 | |
| SW-BL2-Batch2 | 1900 | 3500 | |
| SW-BL2-Batch3 | 2400 | 4200 | 1.7 |
| SW-BL2-Pilot | 2100 | 3600 | |
| HW-BL | 2000 | 2900 | |
| Reference lignins: | | | |
| Commercial lignin | 2290 | 4450 | 1.9 |
| Indulin AT ^{a)} | 1580 | 3410 | 2.2 |
| Hardwood | | | |
| HW KL^{b} | 1260 | 2310 | 1.8 |

^{a)} J. Ropponen, L. Räsänen, S. Rovio, T. Ohra-aho, T. Liitiä, H. Mikkonen, D. van de Pas, T. Tamminen, Solvent extraction as a means of preparing homogenous lignin fraction. Holzforschung 65 (2011), 543-549.
^{b}Hardwood kraft lignin precipitated from black liquor at pH 2.5 with hydrochloric acid

### Example 2—General Method

Raw Material
Black liquor from softwood and hardwood kraft pulping process
Dry content of the raw material: 10-50 wt-%, Trials done at between 30 wt-% and 50 wt-%

Method
Temperatures of 250 and 280° C.
Residence time less than 1 hour
Self-generated pressure that is the vapour pressure of the black liquor
pH alkaline, above 12
Product purification after the activation and precipitation: the lignin material is purified by acidic washing

In this example, black liquor from softwood and hardwood kraft pulping processes having dry content between 30 and 50 wt-% was placed into a reactor and pH was adjusted above 12 using CO₂ as a pH lowering agent. Then the black liquor was thermally treated in the temperatures of 250° C. to 280° C. under pressures corresponding to the vapour pressures of the black liquor at that temperature for less than 1 hour. Then the pH of the black liquor was adjusted to 9-10 and the activated lignin was separated from the remaining liquid fraction in a centrifuge. The separated lignin was purified using acidic washing and dried.

Table 3 shows the amounts of different phenolic hydroxyl group species (mmol/g) in softwood (SW) and hardwood (HW) lignin samples after the thermal treatment determined by ³¹P NMR. Significantly lower amount of methoxylated guaiacyl units and higher content of non-methoxylated catechol and p-hydroxyphenyl type units was detected compared to a to typical industrial softwood and hardwood kraft lignins recovered by traditional acidic precipitation, showing the activating effect of the method. Total content of phenolic hydroxyl and carboxylic acid groups was also higher, whereas the content of aliphatic hydroxyl groups was lower.

TABLE 3

| | Aliphatic | Carboxylic | Condensed | | | p-OH- | Phenolic | Total | |
|---|---|---|---|---|---|---|---|---|---|
| mmol/g | OH | acid | (+syringyl) | Guaiacyl | Catechols | phenyl | OH | OH | % OCH3^{c)} |
| Softwood | | | | | | | | | |
| SW-250C | 0.6 | 0.7 | 2.7 | 1.2 | 1.9 | 1.4 | 7.1 | 8.4 | |
| SW-280C | 0.4 | 0.8 | 2.4 | 1.1 | 2.1 | 1.6 | 7.1 | 8.3 | |
| Reference | | | | | | | | | |
| lignins: | | | | | | | | | |
| commercial | 1.7 | 0.4 | 2.0 | 2.3 | 0.00 | 0.2 | 4.4 | 6.5 | 12.9 |
| lignin | | | | | | | | | |
| Indulin AT^{a)} | 2.0 | 0.2 | 1.6 | 2.3 | | 0.3 | 4.3 | 7.6 | 14.6 |
| Hardwood | | | | | | | | | |
| HW-250C | 0.4 | 0.8 | 3.3 | 0.7 | 1.7 | 1.1 | 6.8 | 8.0 | |
| HW-280C | 0.4 | 0.7 | 3.4 | 0.7 | 1.6 | 1.0 | 6.8 | 7.8 | |
| Reference | | | | | | | | | |
| lignin: | | | | | | | | | |
| HW KL^{b)} | 1.5 | 0.6 | 2.4 | 0.5 | 0.3 | 0.2 | 3.4 | 5.5 | 17.4 |
| Kraft Lignin^{a)} | 0.9 | 0.2 | | | | | 2.8 | 3.8 | |

^{a)}Beis S H (2010) Fast pyrolysis of lignin. BioResources 5(3) 1408-1424
^{b)}Hardwood kraft lignin precipitated from black liquor at pH 2.5 with hydrochloric acid
^{c)}All values measured according to Pregl.

Table 4 shows the average molar mass values of softwood and hardwood lignins determined by SEC in 0.1 M NaOH relative to the polystyrene sulphonate standards. Results show that molecular weight can be affected by varying the conditions of the thermal treatment.

TABLE 4

| | Mn | MW | PD |
|---|---|---|---|
| Softwood | | | |
| SW-250C | 1440 | 2620 | 1.8 |
| SW-280C | 1430 | 2670 | 1.9 |
| Reference lignins: | | | |
| Commercial lignin | 2290 | 4450 | 1.9 |
| Indulin AT ^{a)} | 1580 | 3410 | 2.2 |
| Hardwood | | | |
| HW-250C | 1470 | 2620 | 1.8 |
| HW-280C | 1270 | 2190 | 2.0 |
| Reference lignins: | | | |
| HW KL^{b} | 1260 | 2310 | 1.8 |

^{a)} J. Ropponen, L. Räsänen, S. Rovio, T. Ohra-aho, T. Liitiä, H. Mikkonen, D. van de Pas, T. Tamminen, Solvent extraction as a means of preparing homogenous lignin fraction. Holzforschung 65 (2011), 543-549.
^{b}Hardwood kraft lignin precipitated from black liquor at pH 2.5 with hydrochloric acid

### Example 3—Viscosity Development in Phenol Formaldehyde Resin Synthesis

PF resin synthesis were performed using 100% phenol (PF Ref), and substituting 50% phenol with commercial softwood kraft lignin or thermally separated and activated lignins.

Formaldehyde/phenol ratio of 2 and NaOH/phenol ratio of 0.55 was used according to Danielson et al (1998). For the lignin part, formaldehyde dosage was calculated 1:1 according to the reactive functionalities detected by ³¹P NMR. After complete dissolution of lignin into alkali, the formaldehyde was added slowly at 55-60° C. After that the reaction temperature was increased to 80° C. for the actual condensation phase. The reaction was terminated when the target viscosity of 350-450 cP was reached.

FIG. 2 illustrates the viscosity development in PF (phenol formaldehyde) resin synthesis. As shown in the Figure, the viscosity increase of thermally separated and activated lignin during resin synthesis were faster or slower compared to the commercial reference kraft lignin separated by acid precipitation depending on used separation protocol. This shows that the resin synthesis rate can be adjusted by lignin separation conditions making it easier to control durig resin synthesis, without affecting the resin reactivity. Both the thermally separated and activated lignins have higher curing rate at constant viscosity, as shown in Example 4. Thus, by variable lignin separation conditions, the viscosity increase during resin synthesis can be reduced without loosing the reactivity, making the resin synthesis easier to control.

### Example 4—Resin Curing at High Phenol Substitution Levels According to the Gel Times

PF resin syntheses were performed by substituting 50%, 70% and 90% of phenol with lignin. Commercial softwood kraft lignin was compared with the thermally separated and activated softwood lignins. Formaldehyde/phenol ratio of 2 and NaOH/phenol ratio of 0.55 was used according to Danielson et al (1998). For the lignin part, formaldehyde dosage was calculated 1:1 according to the reactive functionalities detected by ³¹P NMR. After complete dissolution of lignin into alkali, the formaldehyde was slowly added at 55-60° C. After that the reaction temperature was increased to 80° C. for the actual condensation phase. The reaction was terminated when the target viscosity of 350-450 cP was reached.

The curing rate of resins was evaluated according to gel times. An in-house method was used, where a glass test tube with 5 g of the resin was immersed in water bath at 100° C. and the resin was stirred with a glass rod until the tube was lifted with the rod.

FIG. 3 illustrates resin curing at high phenol substitution levels of 50-90% according to the gel times. As shown in the Figure, all thermally separated and activated lignins had shorter gel times at 50% replacement level regardless of the separation conditions used, or origin of black liquor, indicating in all cases faster curing rate compared to the acid precipitated reference lignins. Better reactivity of thermally separated and activated lignins was even more emphasised at higher phenol substitution level of 70% and 90%. The curing rate of reference lignins was significantly reduced at 70% and 90% substitution level unlike with the thermally activated lignin.

### CITATION LIST

### Patent Literature

EP 1794363

EP 2591166

EP 3030598

EP 3036247

U.S. Pat. No. 2,976,273

WO 2012/091906

WO 2016/020383

### Non Patent Literature

Beis, S. H., Mukkamala, S., Hill, N., Joseph, J., Baker. C., Jensen, B, Stemmler, E. A., Wheeler, M. C., Frederick, B G., van Heiningen, A., Berg, A. G., DeSisto W. J., 2010, Fast pyrolysis of lignin BioResources 5(3) 1408-1424

Danielson & Simonson, 1998, Kraft lignin in phenol formaldehyde resin. Part 1. Partial replacement of phenol by kraft lignin in phenol formaldehyde adhesives for plywood J. Adhesion Sci. Technol., Vol. 12(9), 923-939.

Ropponen, J , Räsänen, L., Rovio, S., Ohra-aho, T., Liitiä, T., Mikkonen, H., van de Pas, D., Tamminen, T., 2011, Solvent extraction as a means of preparing homogenous lignin fraction Holzforschung 65, 543-549

Tomani P., 2010, The LignoBoost process, Cellulose Chem. Technol., 44 (1-3), pp. 53-58.

1. A method for activating and recovering dissolved lignin comprising:
providing a feedstock comprising the dissolved lignin and having a pH above 12,
carrying out a thermal treatment of the feedstock having said pH above 12, at temperature within a range of 200-300° C. and for a retention time of 1 hour or less to provide activated lignin within the feedstock,
precipitating the activated lignin by pH adjustment using an acid, thereby providing a liquor comprising precipitated lignin, and
separating the precipitated lignin from the liquor to provide recovered lignin.

2. The method of claim 1, wherein the lignin containing feedstock is from an alkaline pulping process.

3. The method of claim 1, wherein the lignin containing feedstock comprises black liquor.

4. The method of claim 1, wherein a pH adjustment step is carried out before the thermal treatment to obtain said pH above 12.

5. The method of claim 1, wherein a dry content of the lignin containing feedstock during the activation and precipitation steps is between 10 and 50 wt-%.

6. The method of claim 1, wherein the thermal treatment is done at a temperature of 220-280° C.

7. The method of claim 1, wherein the thermal treatment is done at a pressure that is a vapour pressure of the feedstock or greater.

8. (canceled)

9. The method of claim 1, wherein the precipitating is done at a pH of 9-10.

10. The method of claim 1, wherein the precipitating is done with the addition of an acid selected from the group consisting of carbon dioxide (CO₂), carbonic acid, acidic exhaust gas, sulfuric acid, hydrochloric acid, nitric acid, citric acid, and acetic acid.

11. A lignin material produced from the method of claim 1.

12. (canceled)

13. The method of claim 1, wherein the thermal treatment is done at a pressure of between 15 and 90 bars.
